(19) United States
(12) Patent Application Publication
(10) Pub. No.: US 2022/0108285 A1
(43) Pub. Date: Apr. 7, 2022

(54) Methods and Systems for Object Validated Blockchain Accounts

(71) Applicant: Dash Core Group, Inc., Scottsdale, AZ (US)

(72) Inventors: Evan Duffield, Phoenix, AZ (US); Alex Werner, Toulouse (FR); Will Wray, Sutton Quebec (CA); Andy Freer, Yau Tsim Mong (HK); Timothy Flynn, Rochester, NY (US); Nathan Marley, Vancouver, WA (US); Darren Tapp, Chichester, NH (US)

(73) Assignee: Dash Core Group, Inc., Scottsdale, AZ (US)

(21) Appl. No.: 17/530,887

(22) Filed: Nov. 19, 2021

Related U.S. Application Data
(63) Continuation of application No. 16/294,582, filed on Mar. 6, 2019, now abandoned.
(60) Provisional application No. 62/639,315, filed on Mar. 6, 2018.

(51) Int. Cl. G06Q 20/06; H04L 9/06; G06Q 20/36; H04L 9/32

(52) U.S. Cl. CPC G06Q 20/0658; H04L 9/0637; G06Q 20/3672; G06Q 20/3674; H04L 2209/38; H04L 9/3239; H04L 9/3247; H04L 2209/56; H04L 9/0643

(57) ABSTRACT

Some embodiments can include method for decentralized data storage and validation. In many embodiments, the method can comprise receiving provided data at one or more decentralized storage modules for storage, wherein at least one of the one or more decentralized storage modules resides on a masternode, validating the provided data against a defined schema, and obtaining a decentralized multi-party consensus indicating acceptance of the provided data. In a number of embodiments, the method further can comprise writing a hash of the provided data for storage in a blockchain module, synchronizing the provided data across the one or more decentralized storage modules based at least in part on the hash stored in the blockchain module, and retrieving the provided data from the at least one of the one or more decentralized storage modules. Other embodiments of related methods and systems are also provided.

### CROSS-REFERENCE TO RELATED APPLICATIONS

This application is a continuation of U.S. application Ser. No. 16/294,582, entitled “Methods and Systems for Object Validated Blockchain Accounts,” filed Mar. 6, 2019 which claims priority to U.S. Provisional Application No. 62/639,315, entitled “Methods and Systems for Object Validated Blockchain Accounts,” filed Mar. 6, 2018, the contents of which are incorporated by referenced herein in their entirety.

### TECHNICAL FIELD

This disclosure relates generally to blockchain or cryptocurrency accounts, and relates more particularly to systems for persistent accounts, decentralized applications and related methods. This disclosure further describes systems and methods for enabling the creation of decentralized applications accessed via identities established on the blockchain.

### BACKGROUND

Blockchains or cryptocurrencies can be difficult to use, integrate, and access. Today's primary use of cryptocurrency is handled via simple wallet-to-wallet send and receive transactions. There are many uses of blockchain or cryptocurrencies beyond the simple financial transaction which have yet to emerge due to difficulties of use.

A variety of inhibitors to adoption and extensibility of blockchain or cryptocurrency exist due to the decentralized architecture and complex account identification methods. The decentralized architecture relies on a niche peer-to-peer protocol, a limited storage structure, and a closed set of consensus mechanisms. The peer-to-peer protocol is often blocked by networks and is not prevalent among today's software developers. The blockchain can only effectively handle a limited scope of transactions based on its restrictive data format. The consensus rules of the blockchain are specific to the use case of a particular project, not extensible for custom implementations. Besides the challenges of the decentralized environment, blockchain and cryptocurrencies do not easily facilitate commerce between parties. The modern concept of accounts and user names is not found in today's blockchains or cryptocurrencies. Therefore, there is a need for a cryptocurrency network that makes it easier for users to manage and spend their funds within blockchain-centered applications with the convenience of interacting through simple user accounts as opposed to cryptographic addresses.

### BRIEF DESCRIPTION OF THE DRAWINGS

To facilitate further description of the embodiments, the following drawings are provided in which:

FIG. 1 illustrates a block diagram that shows an architectural overview illustrating the main components of a system according to an embodiment;

FIG. 2 illustrates a block diagram illustrating an overview of a method for storing off-chain data according to an embodiment;

FIG. 3 illustrates a block diagram illustrating a method of obtaining consensus on data being stored in the system according to an embodiment;

FIG. 4 illustrates a block diagram illustrating a method of synchronizing storage among peers in the system according to an embodiment;

FIG. 5 illustrates a block diagram illustrating the modules included m a masternode of FIG. 1;

FIG. 6 illustrates a block diagram illustrating a method of registering an application according to an embodiment;

FIG. 7 illustrates a block diagram illustrating a method of registering a blockchain account according to an embodiment;

FIG. 8 illustrates a block diagram that illustrates a embodiment of a computer system; and

FIG. 9 illustrates a flowchart for a method, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a system. In many embodiments, the system can be for decentralized data storage and validation. In some embodiments, the system can comprise one or more processing modules and one or more non-transitory storage modules storing computer instructions configured to run on one or more processing modules and perform acts. In many embodiments, the acts can comprise receiving provided data by one or more decentralized storage modules for storage, wherein at least one of the one or more decentralized storage modules resides on a masternode, validating the provided data against a defined schema, and obtaining a decentralized multi-party consensus indicating acceptance of the provided data. In a number of embodiments, the acts further can comprise writing a hash of the provided data for storage in a blockchain module, synchronizing the provided data across the one or more decentralized storage modules based at least in part on the hash stored in the blockchain module, and retrieving the provided data from at least one of the one or more decentralized storage modules.

Some embodiments can include method for decentralized data storage and validation. In many embodiments, the method can comprise receiving provided data by at one or more decentralized storage modules for storage, wherein each of the one or more decentralized storage modules resides on a masternode, validating the provided data against a defined schema, and obtaining a decentralized multi-party consensus indicating acceptance of the provided data. In a number of embodiments, the method further can comprise writing a hash of the provided data for storage in a blockchain module, synchronizing the provided data across the one or more decentralized storage modules based at least in part on the hash stored in the blockchain module, and retrieving the provided data from at least one of the one or more decentralized storage modules.

Blockchain Accounts.

Blockchain accounts provide the foundation to user access in the system by enabling users to cryptographically prove ownership of a pseudonymous identity they create and persist data related to that identity on the blockchain. These blockchain accounts are registered and managed on the blockchain by means of a special set of account-related transactions (e.g. register, change key).

An account registration associates the chosen user name with the user-provided public key that will be used for future activity. When the account owner creates or updates their data, the data is signed with their account private key. Each blockchain account maintains a “fee-balance” that can be used to pay miners who claim fees for updates to the blockchain account in blocks. This balance is established and refilled using the blockchain or cryptocurrency process known as “burning”. Additional security-related transactions enable the blockchain account owner to update their on-chain public key or close their account.

Masternodes.

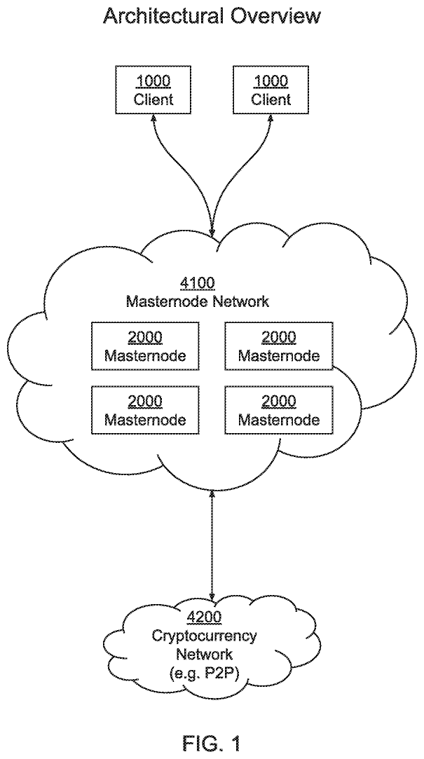

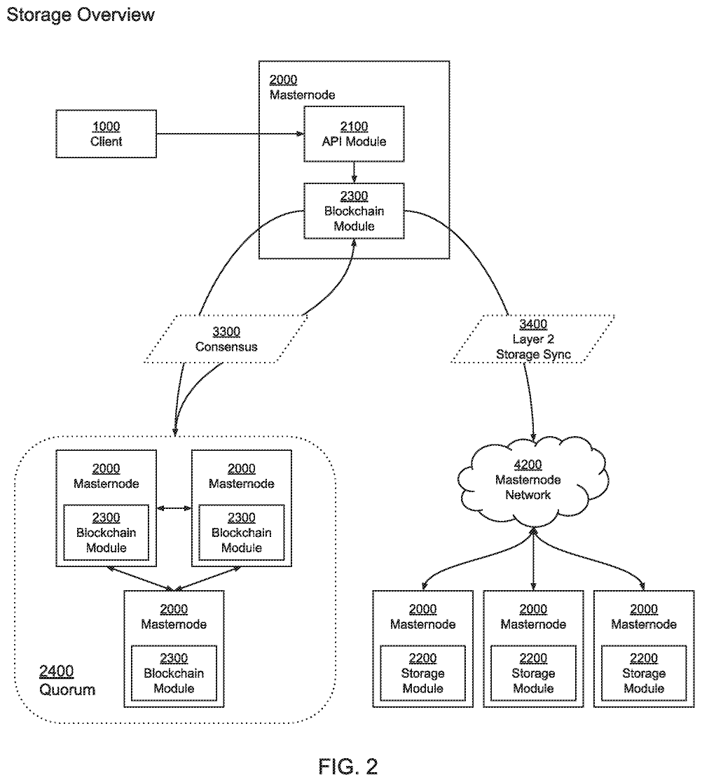

Hosting decentralized network and storage services that are useful for blockchain accounts requires reliable infrastructure on which to base it. Typical cryptocurrency nodes are not well-suited for this since there is not an incentive for them to remaining online, particularly as the demand for resources increases (e.g. storage, network capacity, etc.). To provide an incentive for nodes to support the network as demand increases, the network and storage services described in this patent run on a set of nodes (masternodes) that are rewarded for services provided in a similar way to blockchain or cryptocurrency miners. To ensure these masternodes are invested in the overall system, they are required to maintain a minimum cryptocurrency collateral (e.g. client 1000 (FIGS. 1-2)).

Decentralized API

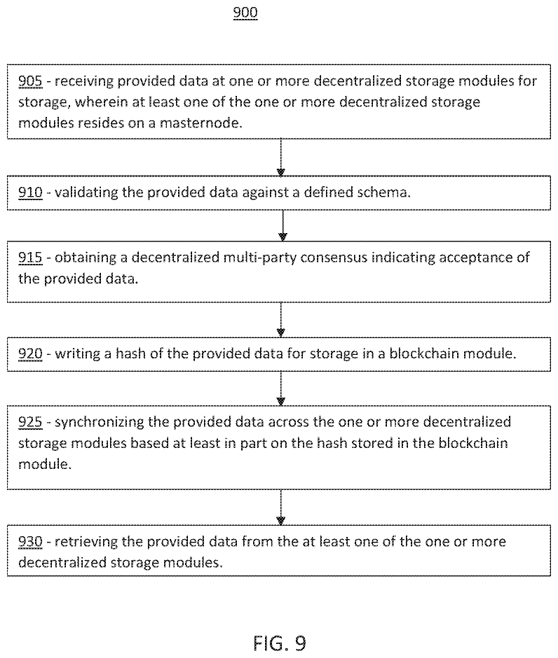

The decentralized API Module (DAPI) provides a means of making cryptocurrency accessible by abstracting away the P2P network layer that is difficult to use and easy to block. This decentralized API acts as an intermediary between the blockchain or cryptocurrency P2P network and other networks (e.g. the Internet) by providing an HTTP-accessible APL To maintain the security of users, DAPI does not have control over account owner's private keys and data submitted or received (e.g., act 905 of method 900 (FIG. 9)) is validated by masternode quorums (e.g., act 910 of method 900 (FIG. 9)) containing two or more DAPI providers to mitigate risk of malicious actors.

Storage

Although DAPI provides advantages for typical blockchain or cryptocurrency use (e.g. financial transactions), using a blockchain to store custom data has numerous limitations such as cost and size constraints. Adding a second layer of Storage, off-chain, enables a much more flexible way to leverage the security provided by the blockchain. To retain data security, a hash for each data update is stored in the blockchain (e.g., act 920 of method 900 (FIG. 9)). The immutability of the blockchain provides a mechanism for validating that that off-chain (layer 2) data remains unchanged.

Unlike blockchain storage, layer 2 Storage can store general data in the form of objects defined by the schema of a particular application. Objects are committed to Storage within differential transactions that each link to the previous update of the object. By traversing all data changes, an ‘Active’ state can be resolved to represent the full current set of data.

Schema

To ensure consistency and integrity of layer 2 storage, all objects stored there are governed by a JSON-based schema which defines the rules as to how they should be validated and their permitted relationships. The base schema defines the overall specification to which all objects in the system must comply. This can be extended by applications to implement sub-schemas to support their custom requirements.

Quorums

Masternodes operating in quorums provide validation for layer 2 related data submitted or provided to DAPI (e.g., act 910 of method 900 (FIG. 9)). A threshold number of members of the quorum (e.g. 6 of 10) must arrive at consensus on the validity of the data in order for it to be accepted, linked to the blockchain, and propagated across the blockchain or cryptocurrency network (e.g., act 915 of method 900 (FIG. 9)). A quorum indicates its approval by adding a quorum signature to the supplied data.

Since participation in quorum activities is one of the services a masternode must provide in order to receive payments, masternodes have an incentive to be responsive to these requests.

Consensus

Consensus rules on the validity and sequence of the data updates added in blocks are analogous to those of Transactions in an existing Cryptocurrency protocol. A combination of Schema validation, masternode quorum acceptance, and the blockchain rules enforced by miners form the consensus that enables layer 2 data storage to remain secure.

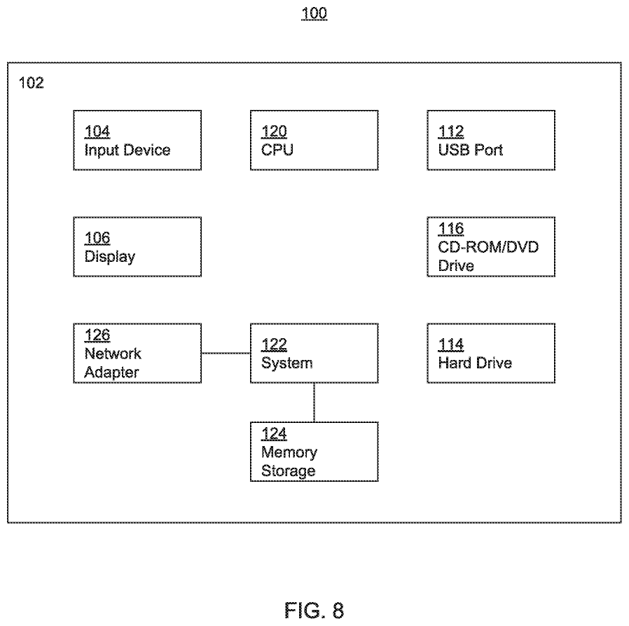

Turning to the drawings, FIG. 8 illustrates an exemplary embodiment of a computer system 800, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 802 (and its internal components) can be suitable for implementing part or all of one or more embodiments of the techniques, methods, and/or systems described herein. Furthermore, one or more elements of computer system 800 such as an input device 804 (e.g., a keyboard, a touchpad, and/or a mouse) and/or display 806 (e.g., a computer monitor or touch screen) also can be appropriate for implementing part or all of one or more embodiments of the techniques, methods, and/or systems described herein.

Computer system 800 can comprise chassis 802 containing one or more circuit boards (not shown), a Universal Serial Bus (USB) port 812, a Compact Disc Read-Only Memory (CD-ROM) and/or Digital Video Disc (DVD) drive 816, and a hard drive 814. A central processing unit (CPU) 820 is coupled to a system bus 822. In various embodiments, the architecture of CPU 820 can be compliant with any of a variety of commercially distributed architecture families.

Continuing with FIG. 8, system bus 822 also is coupled to a memory storage unit 824, where memory storage unit 824 can comprise (i) non-volatile (e.g., non-transitory) memory, such as, for example, read only memory (ROM) and/or (ii) volatile (e.g., transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 824, an external memory storage drive (not shown), such as, for example, a USB-equipped electronic memory storage drive coupled to universal serial bus (USB) port 812, hard drive 814 (a CD-ROM and/or DVD for use with a CD-ROM and/or DVD drive 816, floppy disk for use with a floppy disk drive (not shown), an optical disc (not shown), a magneto-optical disc (now shown), magnetic tape (not shown), etc.). Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 800 (FIG. 8) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 800 (FIG. 8). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 800 (FIG. 8) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 820.

Various I/O devices such as a disk controller, a graphics adapter, a video controller, a keyboard adapter, a mouse adapter, a network adapter 826, and other I/O devices can be coupled to system bus 822. A video controller is suitable for display 806 to display images on a screen of computer system 800 (FIG. 8). A disk controller can control hard drive 814, USB port 812, and CD-ROM drive 816. In other embodiments, distinct units can be used to control each of these devices separately.

Network adapter 826 can be suitable to connect computer system 800 to a computer network by wired communication (e.g., a wired network adapter) and/or wireless communication (e.g., a wireless network adapter). In some embodiments, network adapter 826 can be plugged or coupled to an expansion port (not shown) in computer system 800. In other embodiments, network adapter 826 can be built into computer system 800. For example, network adapter 826 can be built into computer system 800 by being integrated into the motherboard chipset (not shown), or implemented via one or more dedicated communication chips (not shown), connected through a PCI (peripheral component interconnector) or a PCI express bus of computer system 800 or USB port 812.

Although many other components of computer system 800 are not shown, such components and their interconnection are well known to those of ordinary skill in the art. Accordingly, further details concerning the construction and composition of computer system 800 and the circuit boards inside chassis 802 are not discussed herein.

Meanwhile, when computer system 800 is running, program instructions (e.g., computer instructions) stored on one or more of the memory storage module(s) of the various embodiments disclosed herein can be executed by CPU 820. At least a portion of the program instructions, stored on these devices, can be suitable for carrying out at least part of the techniques and methods described herein.

Further, there can be examples where computer system 800 may take a different form factor while still having functional elements similar to those described for computer system 800. In some embodiments, computer system 800 may comprise a single computer, a single server, or a cluster or collection of computers or servers, or a cloud of computers or servers. Typically, a cluster or collection of servers can be used when the demand on computer system 800 exceeds the reasonable capability of a single server or computer. In certain embodiments, computer system 800 may comprise a portable computer, such as a laptop computer. In certain other embodiments, computer system 800 may comprise a mobile electronic device, such as a smartphone. In certain additional embodiments, computer system 800 may comprise an embedded system.

Turning back in the drawings, FIG. 1 illustrates a block diagram of the system. In a number of embodiments, the system can comprise one or more clients 1000 connected to a masternode network 4100 containing two or more masternodes 2000 that provide services and act as an intermediary to a cryptocurrency network 4200.

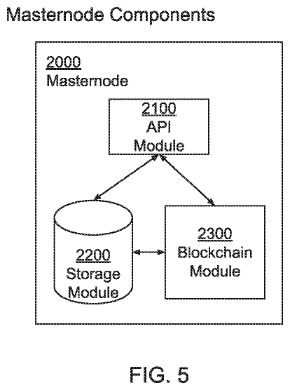

Turning ahead, FIG. 5 illustrates a block diagram of a masternode 2000 which is further comprised of an API Module 2100, a Storage Module 2200, and a Blockchain Module 2300.

FIG. 2 illustrates an overview of the path that Client 1000 data takes to be validated and stored in a decentralized way. Client data first enters the API Module 2100 on a Masternode 2000 and is sent to the Blockchain Module 2300 to obtain Consensus 3300 on the data's validity from a Quroum 2400 comprising two or more Masternodes 2000. Upon obtaining consensus, the Quorum 2400 sends a response to the requesting Masternode's Blockchain Module 2300 which triggers the Layer 2 Storage Sync 3400 once the data is represented in the blockchain. During the Layer 2 Storage Sync 3400, the Storage Modules 2200 of Masternodes 2000 on the Masternode Network 4200 communicate with each other to ensure the data is synchronized across the network (e.g. act 925 of method 900 (FIG. 9)).

Blockchain Accounts

In many embodiments, accounts can be the foundation to user access in the system, enabling users to cryptographically prove ownership of a pseudonymous identity that they create, and persist public and private data related to that identity on the blockchain.

In many embodiments, accounts can be data structures stored on the blockchain that represent the various new types of users that the system serves, such as end-users (e.g. Consumers) and applications (e.g. Businesses), who pay fees to the network in return for adding and updating their account's data, essentially as subscribers to the network.

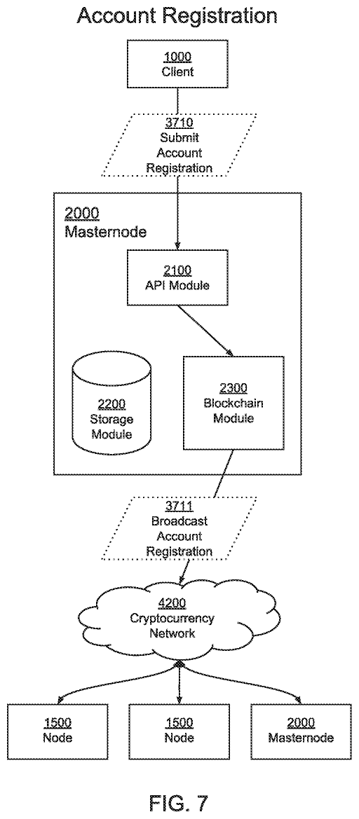

FIG. 7 illustrates a block diagram of a Client 1000 establishing a new account using the architecture as shown in FIG. 1. The Client 1000 submits or provides an account registration 3710 to the API Module 2100 of a Masternode 2000 (and the API 2100 of Masternode 2000 receives such account registration 3710). The API Module 2100 sends this to the Blockchain Module 2300 which broadcasts valid account registrations 3711 to the Cryptocurrency Network 4200. This broadcast works in the same way as typical cryptocurrency transactions (e.g. Bitcoin) and results in all network Nodes 1500 and Masternodes 2000 receiving the registration data.

Account Subscriptions

In some embodiments, users can create accounts by registering subscription data directly on the blockchain in the metadata of specially constructed transactions called Subscription Transactions that also burn a minimum amount of cryptocurrency via a provably unspendable null-data pubkey script in one of the transaction's outputs.

Subscription data for an account can comprise a unique key for that type (e.g. a user name) and a public key that lets the user prove they are the owner of the account by signing challenges. An account can maintain a “fee-balance” consisting of a tallied quantity of cryptocurrency burned on the account that is spent to miners for including updates to the account state in blocks. Note that the public key for the account is purely for authentication and not to be used as a payment address.

Account subscription data can be stored within transaction metadata as the blockchain provides the most security and durability in terms of maintaining a consensus on subscription data, and is accessible and verifiable at a Simplified Payment Verification (SPV) level using existing tools. Also, as the amount of subscription data each account needs to store in transactions during its life cycle is minimal, the penalties of adding this data to the blockchain are minimal too. The amount of this additional data scales linearly to the number of account signups.

Using null-data pubkey scripts in a transaction output to register accounts also can have the benefit that funds can be burned at the same time that are provably unspendable and can provide a “fee balance” for the account (used to incentivize miners to include account state changes in blocks).

Registration

In many embodiments, the transaction metadata needed to create a new account with sample data can comprise:
User name: A string of characters which must be unique within the total Account set on the blockchain for the specified Account Type (similar to a primary key in a database). The User name cannot be changed by subsequent subscription transactions for this Account. In most embodiments, a user name is not a hexadecimal address.
Public Key: The owner's public key for the Account, enabling proof of ownership of the account for the private key holder by verifying their signature against the specified PubKey. This should not be used to hold funds in a Cryptocurrency address, and is purely for authentication purposes.
Signature: A signature of the hash of the preceding fields signed by the owner with the private key for the specified PubKey
Burn Amount: This is the amount of cryptocurrency burned in the transaction output. It must be greater than or equal to a minimum fee for registering the specified Account type (e.g. 0.005 for a User Account). The amount of cryptocurrency burned above the minimum fee is credited to a ‘fee balance’, and is spent on updates to the account later.

Subscription Status

In some embodiments, Alice's account can be identified using the User name

(“Alice”). In many embodiments, the hash of the initial registration transactions can be used to identify Alice's account.

In a number of embodiments, nodes can validate the subscription status of an account by querying the blockchain for all subscription transactions with a given User name, for example, returning all subscription transactions with the user name ‘Alice’, and check that the Account was registered and has not been closed.

Fee Balance

In the above registration example the current balance of the account is derived from the total burned on the account (e.g. 0.01 cryptocurrency), minus the minimum fee for signing up a user (e.g. 0.005 cryptocurrency) (plus any Account update fees which are described later) to tally the account's balance at 0.005 Crypto currency.

Nodes tally this balance by summmg the amounts credited in the initial registration transaction and subsequent top-up transactions existing in the blockchain, and deduct the sum of debits from the account in the form of fees deducted for the subscriber in the blockchain (described below).

Note that the only funds under the control of the subscriber's public key are those available as the account fee-balance which can only be spent by updating objects under the control of that account. Subscribers cannot change data in other subscriber accounts (without their private key) and cannot transfer fee-balances to another account. This minimizes the incentives to hack an account. If a subscriber's private key is compromised, the attacker can only use the available fee-balance to update that Account's data or deactivate the Account.

Topping Up an Account's Fee-Balance

In many embodiments, Account owners can top-up the fee-balance by creating a “Topup” subscription transaction with the registration transaction's hash that burns an additional amount of cryptocurrency. The burned value is credited to the subscriber's account balance when tallying the current account subscription state. It does not need to be signed by the Account owner so anyone can topup an Account's fee-balance.

Changing the Public Key

In some embodiments, the public key for an Account registration can be changed by submitting a “ResetKey” subscription transaction that specifies a new public key. This transaction must be signed with the latest public key in the blockchain for this account to provide a proof of ownership. A “Resetkey” transaction not signed in this way will be considered invalid.

Closing an Account

In the event that a subscriber's private key is compromised and the attacker changes the public key, the subscriber can create a “CloseAccount” subscription transaction and sign it with one of their previous public keys. This effectively deactivates the Account and prevents any updates to the Account data in future.

In many embodiments, to validate the deactivation, nodes can check back for a set amount of time (e.g. 6 months) and allow deactivation on any public key within that period.

In a number of embodiments, this can enable an account owner to prevent unauthorized access to their account, as accounts cannot be re-opened. Although it also means an attacker with the private key could deactivate the account. This would only prevent the rightful owner from updating objects using the account. Since the public key doesn't hold funds, no value is at risk and the user can copy their data and register a new account.

Account Data

In many embodiments, data for an Account can be stored as a collection of data structures called Objects that Account owners can create and update. Objects are comprised of a Header and a Data section that can contain data fields called Properties. The Header can comprise a Property containing the hash of the Data section Properties, so an individual Data section can be matched to a header (e.g., when stored in different locations), and the Header itself can be hashed to provide a single hash of all Properties in the Object.

In many embodiments, Account owners can prove ownership of Objects by signing the header properties with their private key. Nodes can verify this independently using the blockchain.

State Transitions

A State Transition, or Transition, can be defined by the change in state of an Account's data from an old state to a new state. Each new transition references the last transition agreed upon by network consensus.

Because State Transitions are stored in blocks, clients can prove that an Object was part of a State committed to a block by hashing the Object locally and checking a Merkle proof for the Object's branch in the merkle tree.

In some embodiments, certain state transitions, called Delegate State Transitions, can exist where the state is amended using network consensus, for example to ban the account with a sufficient consensus majority.

Accounts can exist purely as a sequence of State Transitions with each one providing a cryptographic proof of the sequence of transitions, the validity of each transition's data via its hash, and proof the data in each transition was created by the Account owner. Each State Transition can contain only a differential set of data Objects that were added or changed in the transition.

Schema

The types of Objects that can be stored, rules as to how they should be validated, and the permitted relationships between objects with different owners, can be defined in a protocol known as the Schema. This protocol enables system components and the applications built on them to communicate effectively by establishing consensus rules and the primitives from which all objects will be derived. System wide consensus rules in the protocol include details such as the method of serializing objects, the hashing algorithm, and the specification for schemas (e.g. JSON-Schema).

In many embodiments, the Schema can be defined in a single reference JSON specification that nodes and clients can interpret programmatically or manually through successive versions and JSON is the native format for interoperation using Objects across all masternodes 2000 and clients. Every Object in the system can be expressed and validated as a JSON Object as defined in the JSON Schema. The relationships and constraints defined in the Schema can be used as reference whenever an Object needs to be validated, stored or acted upon.

In many embodiments, a programmatically interpretable Schema specification can be used to enable the system to decouple Object implementation from Object validation, relay, and storage. For example, Blockchain Module 2300 code can validate an object based on the Schema rules, whilst remaining agnostic to the specific functionality required to handle that Object Type in higher tiers such as the API Module 2100 or client applications. In some embodiments, this can enable the system to modify the Schema and add new Object types in the future without having to re-engineer large amounts of code, or have separate developers working on the Schema design (in JSON) and the various implementations in nodes and clients.

Some additional benefits of using a ‘dynamic’ design-time protocol such as the Schema for Objects comprise:
Blockchain Module 2300/API Module 2100 are object agnostic
End-to-end reference specification for object validation
Decouple business layer from data access layer
Object Oriented nature enables code reuse
Polymorphic code use in Clients (e.g. reuse functionality that processes base class properties and constraints on derived classes)
Enables programmatic code generation for (e.g. Client SDK object sets)

In some embodiments, the Schema can have the properties of both an entity relationship (ER) model and a unified modelling language (UML) model used in Object Oriented Programming (OOP). This means that the system can function similar to a decentralized object-oriented relational database application for end-users and third party applications, where the table rows are instead Objects defined by the Schema's JSON definition at design-time.

Application Schema

The Schema architecture can also be extended to allow third party applications to implement their own sub-schemas to integrate functionality customized for their own requirements. These application schemas extend primitives from the protocol level to define the specific objects and validation rules needed for their use-case. For example, an application may require an object have a minimum value or be limited to certain characters. Application schemas may be reused or extended to add functionality and also may support interaction with other applications via a mutually established protocol.

In some embodiments, application-specific consensus rules can be defined that execute specified logic based on an event (e.g. a change in value of an object).

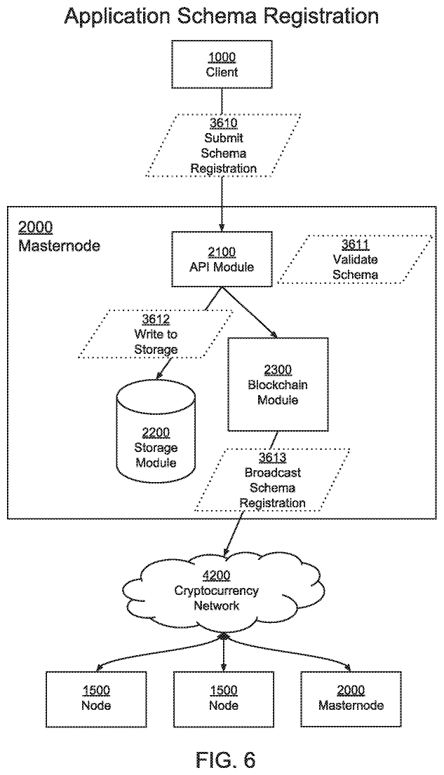

FIG. 6 illustrates a block diagram of a Client 1000 registering a new Schema using the architecture as shown in FIG. 1. The Client 1000 submits or provides a schema registration 3610 to the API Module 2100 of a Masternode 2000 (which can receive such schema registration 3610). The API Module 2100 validates the application schema 3611 using to check compliance with the system Schema. The API Module 2100 writes the application schema 3611 to storage 3612 in the Storage Module 2200, and also sends it to the Blockchain Module 2300 which broadcasts the schema registration 3613 to the Cryptocurrency Network 4200. This broadcast results in all network Nodes 1500 and Masternodes 2000 receiving the registration data.

Interoperability

In many embodiments, the JSON is the native format for Objects in the Schema and the Schema definition itself This enables Objects to be interoperable universally throughout the cryptocurrency network and ecosystem from full nodes to clients, for example:
The Blockchain Module 2300 can relay Objects with other fullnodes using P2P messages
The Blockchain Module 2300 can store and retrieve Objects using local storage
API Module 2100 can read and write Objects to and from the Blockchain Module 2300 using RPC and ZMQ
API Module 2100 can handle HTTP XHR requests and responses containing native JSON Objects
Client Wallets can request and receive Objects from the API Module 2100 and can backup a user's Object Set in native JSON format
Client Applications can request and receive Objects in native JSON format

Payment Objects

In some embodiments, the Schema can also be used to provide access to object-based representations of blockchain data. These Payment Objects are derived from confirmed blockchain transactions and made available as system Objects. This enables applications to access these structures easily if required and for Objects to reference them internally.

Payment Objects may consist of:
Block, Tx and Address are the main object types used in the current payment level of the current Cryptocurrency protocol
Subscription Transactions are null-data transactions with subscription metadata indicating the ownership, status and fee-balance of an Account
Collateral are UTXO with specific metadata used in the system, and in some embodiments are used for Masternode Shares.
SuperBlocks (SBs) that pay winning Proposal Objects are created deterministically by miners in the system, with payments added as outputs in the SB's coinbase transaction.

State Sequences

Some non-limiting example types of Object in the model can illustrate how Object functions are implemented and the sequence of states that multi-party interactions observe using a basic test use-case of for private C2C (consumer-to-consumer) payments.

Requirements

As a simple test case, a user should be able to register an account, and request to ‘add’ another user as a contact, at which point the other user is able to accept or decline that request. If accepted, both users will be able to see the other user in a list of their contacts. If the request is declined, the requesting user doesn't have the option to request again, and the requested user doesn't see the request anymore.

For this test case, the data can be stored using Account Objects. In many embodiments, the data that is stored and the sequence of states in both users' Account Objects at each state throughout the ‘friending’ process are required. Therefore, in this test case it can be assumed that all Objects can be read and written to the network using the rules defined thus far, and as a trustless virtual decentralized database with all data secured by blockchain consensus.

Centralized Solution

In a centralized, trusted relational database with users connecting through a server, requirements can comprise
1. A User table storing all registered users, and
2. A UserContact table storing contact data consisting of a RequesterKey, RequestedKey, and a Response

Users (e.g. Alice and Bob) can both sign up with their UserKey via the server, which creates both rows in the User table. If user Alice wants to request a contact with Bob, she instructs the server to create a new row in the UserContact table, with her key in the RequesterKey column, and Bob's key in the RequestedKey column, and with the Response column's value set to 0, signifying no response.

Bob can be alerted of the request, by scanning the UserContact table for any request to himself without a response, and set the response to either I for “no” or 2 for “yes”. If “no”, the server can filter out the request the next time Bob accesses it, and can prevent Alice from resending a request to Bob. If “yes”, the server can return the User details to each other as an approved contact.

The validation can be taken care of by the database, by ensuring only valid data types can be entered, preventing duplicate users or contact requests through the use of foreign key constraints on the primary keys of both tables

Decentralized Design

In many embodiments. to implement the use-case in a fully decentralized and trustless way using the Account, Object and Schema concepts detailed above, a similar approach to the centralized/trusted database model, with some limitations, can be used:
There is no trusted server with the permission or access to update the data; Both Alice and Bob can only update the data in their own Accounts after proving ownership by signing for their Account's public key.
Data isn't stored in single tables, it's stored in Objects within the user's accounts. Therefore both users need to be able to query Objects from all users that are referenced to them.

The solution to this lies in enabling Account owners (who can only change their own data) to reference data Objects (e.g. state transitions) to foreign accounts (such as a prospective or connected contact) within their own Object data that the foreign account can detect, and respond with data in their own Object set related to the original user.

Referential Integrity

In some embodiments, it can be illustrated that the referential relationships between Objects can be integral to maintaining a global Object set that is correct and does not have duplicated or invalid data that would break Client applications. This provides benefits including:
Enabling validation of Object relations to ensure integrity of the consensus Object Set
Preventing duplicate object instances or misuse of the Schema, e.g. inserting custom data
Enabling extraction of the Object Set to a relational database for integration, analysing or warehousing scenarios
Enabling optimizations in retrieval through optimization of indexing strategies
Enabling optimizations in storage footprint by indexing Object relations

In many embodiments, foreign key relations are implied. This means they cannot be validated using a network consensus, because the key is within an encrypted blob only the User can decrypt. In such cases relational integrity is reliant on correct Client implementations.

In some embodiments, Client applications could use encrypted blobs as the storage unit for custom properties and implement their own custom functionality for state-sequence interoperation within the Objects and relations.

State Sequence

With the Objects and relations defined, how the system implements database-like functionality for end-users but in a decentralized and trustless way, which we call a State Sequence, can be explained.

In many embodiments, the State Sequence can enable sets of Accounts who want to interact to communicate information by only changing their own Object data, with states transitioning in the kind of sequences found in a centralized database application, but with users changing their own data.

The design pattern is similar to a semaphore, where users change their own state referencing a foreign account who is observing any changes in account objects related to their account.

Consensus

In many embodiments, the system can add consensus rules to the Cryptocurrency protocol governing, the consensus rules comprising:
Consensus on the existence, status and ownership of Accounts, based on the sequence and funding of an Account's Subscription Transactions
Consensus on the sequence and validity of State Transitions
Consensus on the state of Objects within each State Transition
Consensus on Object definition and validation rules defined in the Schema

Persistence Strategy

Before detailing the consensus rules, 2 new persistence requirements can be identified based on the above design, each with very different characteristics:

State Transitions (Transitions between Account States) can require a small, fixed amount of data (e.g. −200 bytes) to be stored when data is changed, regardless of the amount of data changed.
1. In many embodiments, more than one object updates can be batched into a single State Transition and full nodes must persist a full set of historical transitions to validate that new states satisfy the consensus rules. These differential Object datasets, called each State Transitions, can comprise a hash of the data and the data itself The Object hashes and data may not be needed for historical validation using consensus rules, and can be pruned after a minimum time when some data is required for triggers. In some embodiments, the minimum time can be approximately I day, I week, I month, 3 months, 6 months, I year or 2 years. In some embodiments, the data can be of variable size. In some embodiments the data can be large (e.g. approximately I 0 Kb) depending on the number of Objects comprising the State Transition data.
2. Active Dataset is the dataset of Objects representing the current (or ‘Active’) set of data. It can be derived and made available by traversing previous differential state transitions and is updated when a new State Transition occurs that changes dataX

In some embodiments, we are faced with 2 different types of persistence requirements. State Transitions require full durability across all nodes which scales approximately linearly to the number of transactions (presuming transitions are being used as essentially metadata facilitating transactions). The Active Dataset only persists the current state of user data and therefore scales linearly to the number of users (generally speaking).

For these reasons, in many embodiments, State Transitions can be stored directly in blocks using a process analogous to transactions. Storing in blocks is ideal as full durability is required. The impact on block size is comparatively small since state transitions are smaller than normal transactions and created less frequently.

For the Active Dataset, blocks may be unsuitable due to their immutability.

Therefore a more efficient storage mechanism can be used that essentially stores sets of mutable Objects based on the state transitions in new blocks. This mechanism is referred to as the Storage Module 2200 and is discussed further below.

State Transitions

State transitions can represent the sequence in changes to state and metadata can be added to blocks by miners, and include a hash of the previous transition for the account.

The properties in the State Transition are comprised of:
The hash of the transaction registering the associated Account
The previous subscription transaction hash for the associated Account, i.e. the source state
The hash of the data being submitted or provided, i.e. the destination state
The signature of the data by the Account's most recent public key
The signature of the State Transition by a masternode quorum 2400

Incentives

In many embodiments, the incentive for Masternodes 2000 to form Quorums 2400 to accept and propagate state transitions and store their data is because Masternode rewards are dependent on their processing of these transitions. In some embodiments, this entails achieving a minimum quota of state transitions in blocks based on the total Masternode activity within a fixed time.

The incentive for miners to add state transitions to blocks is because they earn fees on each transition added which are deducted from Account's tallied balance and issued to the miner in an additional coinbase output paying the sum of all fees on state transitions included in the block.

Transition Verification

Each node verifies a transition as follows:
Check if the state transitions are well formed and use the correct syntax
Check the associated Account is valid and open status based on the associated subscription transactions starting with the referenced registration tx hash
Check if the Account fee−balance can afford the commit cost (balance−fees>0)
Add the fees to the coinbase (this is deducted from the account's burn tx by checking the blockchain)
Verify Objects provided with the transition are well formed and use the correct syntax
Validate Object properties using the rules in their associated Schema definitions
Verify that relations in Object headers map to valid Objects in the Active Set
Verify the owner signature is the transition hash signed for the public key associated to the pubkey in the account's active subscription state (i.e. the most recent ‘register’ or ‘resetkey’ subscription transaction)
Check the previous transition hash is the last transition for this account
Determine the correct quorum 2400 for the Account
Verify the quorum signature based on the quorum's public key

Block Protocol

Consensus rules on the validity and sequence of State Transitions added in blocks can be analogous to those of Transactions in an existing Cryptocurrency protocol.

In many embodiments, miners can collect new Transitions into a block where they're hashed into a Merkle Tree with only the root included in the block's header, enabling Clients to validate whether a specific State exists in a block using a simplified verification process and enabling state transitions for closed accounts to be pruned.

The root hash of all Transitions in the block can be hashed as part of the block header during Proof-of-Work to gain consensus on the new state of all objects that have transitioned since the previous block.

In some embodiments, the solution can be scalable because each Account can have only one State Transition per block regardless of the amount of data that changed. This minimizes the impact on block growth to approximately 200 bytes per Account whose state has changed per block. If there were I million unique accounts updating objects once per day, this would add roughly 347 Kb per block in a cryptocurrency with an average of 576 blocks per day at the 2.5 minute target interval.

Block Header

The format of the block header remains unchanged since State Transitions are simply a specific type of transaction and all transactions are hashed to create the block's merkle root. Based on this, SPV validation of State Transitions works in the same way that validation of normal financial transactions does.

Block Validation

Additional consensus rules for Block validation comprise:
Verify each transition
Check the coinbase transaction fee output amount is the sum of all fees (transaction fees plus any fees paid via an Account fee-balance)

Altered consensus rules for Block validation:
Since State Transition fees are paid from the Account's fee-balance, State

Transition transactions do not need to include any inputs or outputs

Storage

In many embodiments, the Storage Module 2200 can be the storage mechanism for Objects, which are the data notarized in the Transitions between states stored in blocks. In some embodiments, a middle layer or Tier-2 (the data storage tier) can comprise the storage mechanism.

In some embodiments, a transaction or a transaction class can allow data storage as serialized data objects (e.g., state transitions) related to all required objects. In some embodiment, transactions that have a balance of greater than or the same as a threshold amount can be considered valid. In many embodiments, transactions that have a balance less than a threshold amount can be considered invalid. This can allow for purging and/or pruning of data by users (e.g., by moving money, credit, or currency).

Data Types

In some embodiments, for each State Transition added in a new block, the Storage

Module 2200 stores:
The merkle tree hashes for all Objects in the Transition
The Object data, containing public and private properties for the Account and related Accounts

Committing Data

Objects can be committed to the Storage Module 2200 within differential state transitions that are included in a new block. By traversing all application state transitions for an Account since it was registered, an ‘Active’ state can be resolved to represent the full current set of an Account's application data. The Active state can be updated whenever a new block contains a transition. In some embodiments, access to pending state transitions can allow visibility into uncommitted changes.

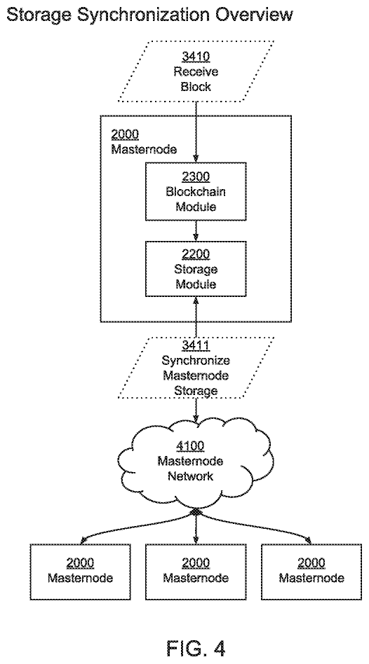

FIG. 4 illustrates the Layer 2 Storage Synchronization 3400 (which can be similar to the synchronization of act 925 of method 900 (FIG. 9)). When a block is received, as shown in 3410, by the Blockchain Module 2300 of Masternodes 2000, the Storage Module 2200 parses the block for state transitions and identifies any for which it does not have the associated data. The Storage Module 2200 of the Masternode 2000 synchronizes Masternode Storage 3411 with other

Masternodes 2000 via the Masternode Network 4100 to retrieve any data it requires (e.g., act 930 of method 900 (FIG. 9)).

Scalability

The Storage Module 2200 can provide a scalable solution because nodes only need to keep the current state of an Account's application data (the Active dataset) and update this on new State Transitions. This means that the data for many differential states can be pruned, for example a user updating their profile 100 times results in only 1 copy of the profile Object being stored on nodes.

An exception to this is that some differential states may need to be kept for a limited period for block validation, based on the prune depth definition for the Object type in the schema.

This design is aimed at everyday user access patterns. For example, a typical user may not care about seeing all past revisions of their profile information, they are just concerned with the active set that other users will see. If data revisions from the inactive set are needed by a user and they were pruned from the network, only a single copy of a revision is needed to restore the state because the hash of the data can be validated against the associated State Transition in a block and the signature validated against the user's Subscription Transactions. This means that users who want to keep revisions can recover the data from a location such as their local backup (which a Client could be configured to keep) or a website listing historical data and validate the Object's authenticity and presence on the blockchain. Alternatively, users wishing to keep every revision can run their own full node with pruning disabled on their account.

Effectively, data are notarized in blocks, with the notarized data stored in parallel storage that's pruned to a set-size relating to the number of end-users rather than the number of transactions that they are adding to the chain.

The key reason to use a secondary store that extends each block is that blocks are best suited to retain full data on the transitions between states, whereas the Storage Module's 2200 main use-case is to maintain a current ‘Active’ state for an Account's application data, with deprecated states being pruned at a certain depth, e.g. after I month (depending on the Object definition in the Schema).

Storage Architecture

The requirement of how to store State Transitions in the Storage Module 2200, i.e. storing differential sets of Objects associated to transitions of Account states included in blocks, is similar to storing rows in a database table, but in a database that keeps past versions of the row as new transitions arrive. In this case, the last row added is considered the active row.

Using this principle, it can be noted that all Objects in the Storage Module 2200 are owned by Accounts. In many embodiments, the Objects are also associated with an application identity. Together they form the top level partition, or dimension, for Objects in terms of organizing their storage strategy. In some embodiments, some Objects may be associated with an Account only and not related to a particular application identity.

The second dimension in the Storage Module 2200 occurs from the fact that data is added in conjunction with a new block, with the Objects tied to a state transition in a block through the root hash of all Objects related to that transition.

When an Account interacts with an application schema, a new partition is created in the Storage Module 2200 for the Account's data associated with the application. As Account owners create state transitions, the corresponding new or updated Objects in the Account are committed to the Storage Module 2200 as a new row, with the first row representing the resolved Active State of all past data transitions for the Account.

In some embodiments, a 2-dimensional State Transition storage structure can be modeled as a data cube, with the total set of registered Accounts forming the X-axis, and the Z-axis representing historical additions and updates of Objects leading up to the current active state.

A third dimension can be created in the data cube on the Y-axis by grouping Objects by Schema type. This can enable optimizations based on the different usage and verification requirements of types, for example constructing and verifying state transitions for Object ratings would require fast searching of Rating trigger Objects by miners preparing a new block to minimize verification Costs.

Data Partitioning

The Storage Module 2200 data can also be pruned on a per-account basis on Nodes without the capacity to store the full Object dataset, either randomly or based on Accounts that are closed or haven't had activity for a long time (e.g. 12 months, 18 months, 2 years or 5 years).

In such a case, only a single node with a copy of the data is required to restore it, or the data can be recovered from a backup or archive source.

In some embodiments, a limitation to partitioning the data as such, is that the Object headers containing the foreign key relations may be needed to perform relational validation historically. As a non-limiting example, to validate a contact request from Alice to Bob, the consensus rules dictate that Bob must exist to maintain the relational integrity of the overall Object set in the Storage Module 2200.

In some embodiments, Transitions can be pruned based on Object Type. As a non-limiting example, Object transitions can be pruned based on a parameter specified in the Object's Schema definition.

In some embodiments, a reason to use an informal, ad-hoc approach to partitioning instead of a formal sharding strategy is that formal sharding can weaken the durability of the data because attackers can target specific data with knowledge of the subset of nodes that are storing that data. There is also an overhead to formal sharding with the need to organize and rebuild shards as nodes turnover, as opposed to nodes for example randomly pruning old Accounts when they run low on disk space.

Decentralized API

The API Module 2100 is the decentralized Application Programming Interface that enables the system end-users and applications to connect directly to the cryptocurrency P2P network to read/update Account data and read/create Transactions using HTTP enabled clients such as browsers and mobile applications.

Network Architecture

The API Module 2100 is part of a re-architecting of cryptocurrency network design to introduce a way for Clients to access the P2P network securely and directly.

In the current cryptocurrency design (inherited from BITCOIN), there is not a protocol level definition of a Client as is typical in most service models (such as Client-Server). In cryptocurrency, every user is expected to access via a P2P node and interact as a peer directly. This was an understandable assumption in the early versions of BITCOIN, where every node mined, audited, and maintained a full local copy of the blockchain. The expansion into browser/mobile applications and attempts to integrate with more mainstream systems has made the P2P protocol an obstacle to growth.

There are different modes of P2P node that users can operate under in the existing architectures, with the closest thing to a client being a user operating a node without a copy of the blockchain and using SPV validation over P2P messaging, essentially a selfish node, and when mediated via a centralized proxy, referred to as a ‘lite client’, e.g. ELECTRUM.

For these reasons, the API Module 2100 can be the endpoint for a new Client Protocol that is adjacent to the existing P2P Network Protocol, with Clients being any device running software that connects to the API Module 2100 over HTTP using the correct interoperation protocol.

Security Model

In some embodiments, the security model for the API Module 2100 and its clients is based on this non-P2P selfish SPV node model, whereby Clients can connect to Nodes and add data to the blockchain (Transactions and Transitions) without needing to participate as peers and using the most commonly supported and censorship resistant protocol, HTTP. Clients can also access any node in the network to validate Transaction and Transition data using SPV over HTTP.

In many embodiments, the API Module's security model can be based on full ownership of private keys by client users, with private keys never entering the API Module 2100. This prevents the API Module 2100 from having access to user funds. The API Module nodes may not serve code or content (e.g. JavaScript or HTML) to a browser. In many embodiments, the API Module 2100 can be purely an XHR over HTTP based API accessed by deterministically-built open-source clients.

In many embodiments, the API Module 2100 nodes utilize Masternode Quorums 2400 (e.g. 6-of-10) to confirm the validation of Client requests and the content of Client responses. In some embodiment, Quorums 2400 provide redundancy to uncommitted Client session data and reduce the chance of malicious nodes wasting Client time with responses that Clients subsequently invalidate using SPV (with the Client SPV process being applied externally to the Client's Quorum 2400, i.e. network wide).

Network Topology

The connection topology for Cryptocurrency can bifurcate into 2 rings in the network. The current P2P network topology (technically a partially-connected mesh) can become the inner ring consisting of P2P nodes that validate, persist and provide the blockchain to other P2P nodes. The outer ring consists of individual Clients connected directly to a cluster of collateralized P2P nodes serving HTTP requests (Client/Multi-node-server) instead of intermediary proxy services that connect P2P on the backend, which we call the Client-to-Peer (C2P) network, technically a Client-to-collateralized-Peer-quorum network, also known as Tier-3 in Cryptocurrency.

In some embodiments, an issue with this structure can be the incentives model or specifically lack of incentivizes for full nodes to support a very-large amount of selfish nodes. In some cryptocurrencies, the incentive model is pure P2P based, i.e. overall the P2P network survives with enough nodes seeding (operating as relaying full nodes accepting inbound connections) in the network to handle the additional traffic from a relatively small amount of leechers (mostly desktop wallets, centralized proxies such as SPV proxies, web wallets and payment processors) which end-users and applications connect to. By removing the need for leechers to connect via proxies (i.e. the majority of end-users not wishing to participate or support the P2P network directly), and therefore resulting in a large increase in selfish nodes (clients who can now access the network directly instead of via centralized SPV or Web wallet proxies), the cost to running a full node increases and the incentives model of the P2P network is broken.

In many cryptocurrencies, nodes can be incentivized to provide non-mmmg services, but not specifically to handle this new topology, i.e. currently nodes could still be rewarded without provably serving these end-users honestly. To solve this, collateralized nodes (Masternodes) rewards can be altered to be provisional on the amount of Client data they add to the blockchain (technically, the quantity of Account State Transitions), which can provide incentives to users who choose to operate nodes that will serve HTTP Clients and a deterministic way to ensure only nodes providing an adequate (and honest) Client-service level are rewarded.

Client Protocol Quorum

In many embodiments, there are two modes of connection Clients can use:

Passive Sessions—Anonymous, read-only access to the Account API (to query Account data), and anonymous read/write access to the Payment API (to query the blockchain and create transactions)

Interactive Sessions—All the abilities of a passive session plus the ability to pseudonymously update the data for Accounts to which the user holds the private key.

In a number of embodiments, when an Account Owner wants to start a session (i.e. update their Account state) with the API Module 2100 from a Client, there are several steps to perform. In some embodiments, this may not be needed for reading data on any Account in cryptocurrency, as clients can query any API Module node for the data anonymously. Also, this may not preclude users accessing the API Module 2100 from a local full node if they want full validation of all interaction using a full copy of the blockchain and related data.

The first step is to obtain a list of valid Masternodes 2000, and secondly to determine which Masternodes 2000 to which their client must connect to be able to update their account state.

Obtaining the Masternode List

A Client can connect to any number of nodes in the cryptocurrency network to obtain the Masternode list and validate its contents using SPV, using essentially the same security model as SPV/Electrum clients but with a much higher degree of decentralization, i.e. Clients can access any node in the cryptocurrency network instead of having to proxy through a small set of centralized layer-2 servers, and as that access is HTTP based, it is available from any HTTP enabled Client, such as a web browser

Clients can use HTTP DNS seeds that the community setup to build an initial list of Masternodes 2000 to connect to in the same way as the core wallet today.

Once connected to some initial API Module nodes, the Client can retrieve a list of all Masternodes 2000 and their IPs, and validate the Active status using SPV on the on-chain Deterministic Masternode List to avoid spoofed nodes from a DNSseed.

Quorums

In many embodiments, a group of deterministically selected masternodes 2000 forms a quorum 2400 that can provide consensus on the the validity of transactions such as State Transitions. Quorum members indicate acceptance of a State Transition by collectively signing it in a way that is verifiable using the quorum's public key which is stored on the blockchain.

In many embodiments, the Masternode Quorums 2400 are constructed and operated by the Blockchain Module 2300. Quorums 2400 of varying sizes (e.g. 10, 50, 200) and approval thresholds (e.g. 6 of 10, 30 of 50, 125 of 200) may exist to support differing requirements.

A Client's quorum 2400 is selected based on the registration transaction hash of the Account accessing the Quorum 2400. Once a Client has constructed a valid active Masternode list, they can determine their quorum 2400 and connect to it.

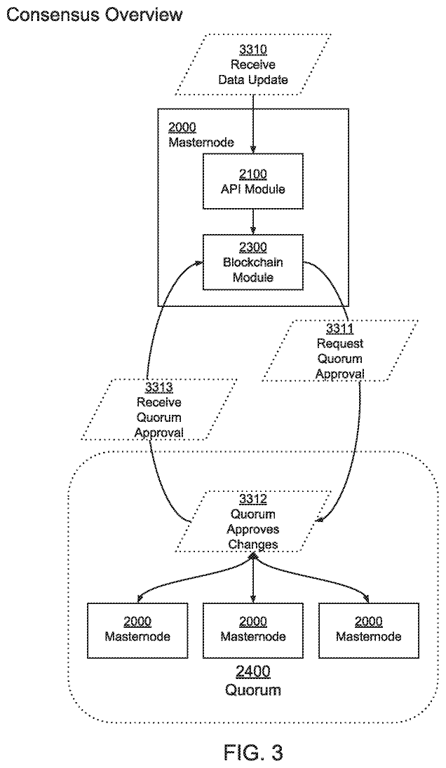

FIG. 3 illustrates a block diagram of a obtaining a Masternode Quorum's 2400 consensus on a data update 3310. When the API Module 2100 of a Masternode 2000 receives a data update 3310, it sends it to the Blockchain Module 2300 after verifying the structure against the relevant schema. The Blockchain Module 2300 requests quorum approval 3311 from the group of Masternodes 2000 in the Quorum 2400. Once the minimum number of Masternodes 2000 approve the change, a member of the Quorum 2400 sends a message indicating the Quorum 2400 approves the change 3312. When the Masternode 2000 requesting approval receives the quorum approval 3313, it continues processing the data update. In many embodiments that entails broadcasting a transaction related to the data change for inclusion in the blockchain.

Client Created State Transitions

In some embodiments, Clients 1000 submit or provides assembled State Transitions and the related objects to the API Module 2100 (which can receive such assembled State Transitions and related objects) to request inclusion in a block. The API Module 2100 sends the State Transition to the Client's quorum 2400 to obtain majority consensus and subsequently propagates it to the cryptocurrency network once the quorum signature is received.

Quorum Created State Transitions

Creation

In some embodiments, State Transitions from users can be created during interactive Client-Quorum Sessions, during which time the designated Quorum 2400 caches any updates to the Account's Data Objects and at set intervals or heartbeat (e.g., approximately I minute, 2.5 minutes, 5 minutes, or 10 minutes) propagates these as a batch representing a new State to nodes in a State Transition data structure.

If validated, the State Transition has its data included in a block by miners for a fee deducted from the Account's tallied fee-balance. This data (that was notarized by the transitions inclusion in the block) will be included in Object Storage by Masternodes 2000 who must facilitate a minimum quota of State Transitions to receive their portion of the block reward.

We call the intervals (e.g., 2.5 minute State Transition propagation by Quorums 2400) a ‘heartbeat’, which is designed to minimize the frequency of transitions to an account on the blockchain, whilst still occurring frequently enough to provide usability. Client's have the ability to control this frequency, or raise a state transition at any time to ‘save’ their data in the next block.

Authorization

Once the Quorum 2400 has assembled the State Transition, it sends it to the Account's connected Client(s) for authorization using a web-socket callback or as part of a poll response.

Each Client can compare the root hash of the merkle tree for their local Object set to the root hash in the State Transition, and if it is valid, signs the State Transition hash with their Account private key and sends it back to the quorum 2400 who propagates it to the P2P network.

Triggers

Triggers are Objects types that have hardwired functions in nodes, such as rating accounts, budget cycle and masternode payments. Essentially, consensus rules depend on the data of a small number of types in the Schema.

In some embodiments, the actual derived object types may not be wired, but just signify in the Schema that certain Objects are types that cause triggers.

As a non-limiting example, if a User rates an App in the header of their UserApp Object, that Object has a type in the Schema signifying it has a header that raises ratings.

Nodes can remain agnostic to the specific Schema, but when Objects have Trigger types, use those Object data for predefined trigger functions.

Note that trigger objects will usually have a higher prune depth. For example, all

Budget objects need to be kept for at least I budget cycle (approximately I month, 2 months, 3 months, 6 months or I year) for nodes to be able to validate Superblocks using consensus rules.

Ratings

In some embodiments, ratings are intrinsic to the system. They provide a democratic and decentralized way for users to apply a score to other Accounts (such as Users and Apps) that they use and to report users that break the Cryptocurrency Terms of Service. Those Accounts can be closed by Masternode voting if a minimum consensus is reached.

Note that having an Account closed can never result in the loss of funds by the Account owner or prevent an Account from moving funds. The Account is simply banned from creating any State Transitions and therefore it cannot create or update data Objects. As an example of an absentee account rating via a delegate state transition, the process is:
Alice and Bob both set a rating on their UserApp Object for Charlie's App, which is selling widgets.
A miner collects the State Transitions for Alice & Bob's update into the block and detects the presence of Rating values in the Object dataset
The miner must tally the ratings (based on the total ratings for Charlie's App to date, and the average rating, combined with any new ratings in this block).
Because Charlie has not updated his Account in this block, the miner must create a Delegate State Transition in his absence, which updates the metadata but leaves the Data Transition as null (or just a hash of the last state transition by Charlie

In many embodiments, validating nodes repeat this process to validate that the miner has included the Delegate State Transition for any State Transitions the miner included that contain ratings for Charlie's account

This incentivizes the miner to create the Delegate State Transition data even though they are not claiming a fee directly. This is because they can't include the State Transition from Alice & Bob's accounts without the Delegate State Transition to handle the change in Charlie's rating meta state.

Masternode Shares

Masternode shares can enable Account holders to group together to collateralize a

Masternode Account operator which links to a physical Masternode instance. In this Schema design, share owners receive their share of the rewards deterministically but only the Masternode (MN) account holder can vote on behalf of the node.

Users who wish to obtain MN shares (e.g. Alice & Bob) send an amount (e.g. 500 Cryptocurrency each) to an address they own with specific metadata signifying this as a collateral transaction. The transaction uses CheckTimeLockVerify to prevent movement of the funds for 30 days. This is to reduce turnover rate of MN share owners initially. If they stay with a particular MN operator for over 30 days, they can move the funds instantly.

A Masternode Account owner (e.g. Charlie) can ‘claim’ Alice & Bob's collateral transaction by adding the transaction hashes to a new CollateralStatus Object in his dataset (or updating the existing CollateralStatus Object if one exists). The collateral transactions can only be claimed by one Masternode Account.

To verify that the Masternode Account is fully collateralized, nodes check the Account's CollateralStatus Object data as follows:
The Collateral transactions listed in the Object are unspent and not claimed by any other Masternode Account.
The Collateral transactions sum to at least the minimum MN requirement or minimum collateral requirement (e.g. 1000 Cryptocurrency)

In some embodiments the maximum number of shares is 20 per Masternode, but individual shares can be any amount over 5 Cryptocurrency. The Masternode Account owner must provide at least I 0% of the total requirement themselves to increase the cost to setup a malicious masternode. Note that the share owners are not risking funds as they do not share their private keys.

Governance

There are 2 Trigger Objects used for the Governance budget cycle: AppBudgetProposal and MasternodeBudgetVotes Objects, handling budget proposal creation and voting by Masternodes. The state of these Objects across the global Object set can determine Superblock creation and validation by nodes, which pay out the 10% of Block rewards each month to the winning proposals (using the existing consensus rules for SB validation).

Proposal Creation

Apps can create a new budget proposal by creating a new AppBudgetProposal and setting the properties for Name, Description, URL, PayDate, NumPayments, PayAmount, PaymentAddr.

Voting

To vote on a proposal, a Masternode Account owner updates their MasternodeBudgetVotes Object with a reference to the AppBudgetProposal, and adds their yes/no/abstain via the Vote property. Note that the MasternodeAccount has to pay fees for a State Transition to cast the vote (unless a solution can be found).

Super Blocks

In some embodiments, superblocks can be created deterministically by miners in the system, by the miner querying and all MasternodeBudgetVotes Objects within State Transitions included in blocks since the last budget cycle period and tallying the votes.

The mmer can add the appropriate associated payments in the coinbase transaction (using the budget finalization rules from the current system) with the process repeated for verifying nodes.

Note that nodes must maintain full object data for all governance objects to a certain depth (e.g. not prune until I month)

System Admins

In some embodiments, administration of the system (i.e., deactivating Subscriber Objects) will be a simple function of achieving a certain % of Masternode votes (e.g. 5%, 10%, 15%, 20%, 25%, 30%, 35%, 40%, 45%, 50%, 51%, or 66% and 2/3%) to ban Accounts.

In a number of embodiments, to ban an Account, users can ‘report’ an Account using a similar system to ratings. Masternode admins can vote on these bans using their AdminVotes Object, which miners must create a delegate state transition for the Account being voted on with a ban rating and total in the next block. When the votes reach a ban level, the miner of the next block must set a delegate state transition for the Account being reported with the Status set to ‘Closed’ for the block to be accepted via consensus rules.

Moving ahead in the figures, FIG. 9 illustrates a flow chart for a method 900, according to an embodiment. Method 900 is merely exemplary and is not limited to the embodiments presented herein. Method 900 can be employed in many different embodiments or examples not specifically depicted or described herein. In some embodiments, the activities of method 900 can be performed in the order presented. In other embodiments, the activities of method 900 can be performed in any suitable order. In still other embodiments, one or more of the activities of method 900 can be combined or skipped. In many embodiments, the systems of FIGS. 1-8 can be suitable to perform method 900 and/or one or more of the activities of method 900. In these or other embodiments, one or more of the activities of method 900 can be implemented as one or more computer instructions configured to run at one or more processing modules and configured to be stored at one or more non-transitory memory storage modules. Such non-transitory memory storage modules can be part of a computer system as shown in FIGS. 1-8. The processing module(s) can be similar or identical to the processing module(s) described above with respect to computer system 800 (FIG. 8).

In many embodiments, method 900 can be a method for decentralized data storage and validation. In many embodiments, method 900 can comprise act 905 of receiving provided data by one or more decentralized storage module for storage, wherein each of the one or more decentralized storage module resides on a masternode. Method 900 further can comprise act 910 of validating the provided data against a defined schema. In a number of embodiments, method 900 further can comprise act 915 of obtaining a decentralized multi-party consensus indicating acceptance of the provided data and act 920 of writing a hash of the provided data for storage in a blockchain module. In many embodiments, method 900 further can comprise act 925 of synchronizing the provided data across at least one of the one or more decentralized storage module based at least in part on the hash stored in the blockchain module and act 930 of retrieving the provided data from at least one of the one or more decentralized storage modules.

Although methods and systems for object validated blockchain accounts have been described above, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed:

1. A system for decentralized data storage and validation comprising:
one or more processing modules; and
one or more non-transitory storage modules storing computer instructions configured to run on one or more processing modules and perform acts of:
receiving provided data by one or more decentralized storage modules for storage, wherein at least one of the one or more decentralized storage modules resides on a masternode;
validating the provided data against a defined schema;
obtaining a decentralized multi-party consensus indicating acceptance of the provided data;
writing a hash of the provided data for storage in a blockchain module;
synchronizing the provided data across the one or more decentralized storage modules based at least in part on the hash stored in the blockchain module; and
retrieving the provided data from the at least one of the one or more decentralized storage modules.

2. The system of claim 1, wherein:
receiving the provided data at the one or more decentralized storage modules for storage comprises receiving the received data via a decentralized API.

3. The system of claim 2, wherein:
the decentralized API comprises a communication module on the masternode; and
the communication module communicates with the at least one of the one or more decentralized storage modules by:
sending and receiving one or more data transfer requests related to the provided data;
and
sending and receiving one or more data transfer results related to the provided data.

4. The system of claim 3, wherein:
the communication module on the masternode further communicates with the blockchain module.

5. The system of claim 1, wherein the acts further comprise:
validating the provided data by comparing the provided data against one or more rule sets; and
updating a decentralized database through a quorum consensus.

6. The system of claim 1, wherein the acts further comprise:
registering a blockchain user account at least in part by using a special transaction type related to the provided data.

7. The system of claim 1, wherein the acts further comprise:
at least one of sending or receiving one or more funds to a blockchain user by sending to a blockchain user name, wherein the blockchain user name is not a hexadeximal address.

8. The system of claim 1, wherein:
retrieving the provided data from the one or more decentralized storage modules comprises retrieving the provided data via a second decentralized API.

9. The system of claim 1, wherein:
the defined schema is stored within the at least one of the one or more decentralized storage modules.

10. A method for decentralized data storage and validation comprising:
receiving provided data at one or more decentralized storage modules for storage, wherein at least one of the one or more decentralized storage modules resides on a masternode;
validating the provided data against a defined schema;
obtaining a decentralized multi-party consensus indicating acceptance of the provided data;
writing a hash of the provided data for storage in a blockchain module;
synchronizing the provided data across the one or more decentralized storage modules based at least in part on the hash stored in the blockchain module; and
retrieving the provided data from the at least one of the one or more decentralized storage modules.

11. The method of claim 10, wherein:
receiving the provided data at the one or more decentralized storage modules for storage comprises receiving the received data via a decentralized API.

12. The method of claim 11, wherein:
the decentralized API comprises a communication module on the masternode; and
the communication module communicates with at least one of the one or more decentralized storage modules by:
sending and receiving one or more data transfer requests related to the provided data;
and
sending and receiving one or more data transfer results related to the provided data.

13. The method of claim 12, wherein:
the communication module on the masternode further communicates with the blockchain module.

14. The method of claim 10, further comprising:
validating the provided data by comparing the provided data against one or more rule sets; and
updating a decentralized database through a quorum consensus.

15. The method of claim 10, further comprising:
registering a blockchain user account at least in part by using a special transaction type related to the provided data on the blockchain module.

16. The method of claim 10, further comprising:
at least one of sending or receiving one or more funds to a blockchain user by sending to a blockchain user name, wherein the blockchain user name is not a hexadeximal address.

17. The method of claim 10, wherein:
retrieving the provided data from the at least one of the one or more decentralized storage modules comprises retrieving the provided data via a second decentralized API.

18. The method of claim 10, wherein:
the defined schema is stored within the at least one of the one or more decentralized storage modules.
